(19) United States
(12) Patent Application Publication
(10) Pub. No.: US 2021/0195883 A1
(43) Pub. Date: Jul. 1, 2021

(54) FISH ATTRACTOR OR LURE

(71) Applicant: Saucy Tackle Company, LLC, Manchester, NH (US)

(72) Inventors: Nicholas Want, Manchester, NH (US); Gerhardt P. Schroeder, Concord, NH (US)

(73) Assignee: Saucy Tackle Company, LLC, Manchester, NH (US)

(21) Appl. No.: 16/492,264

(22) PCT Filed: Mar. 9, 2018
(86) PCT No.: PCT/US2018/021666

§ 371 Date: Sep. 9, 2019

Related U.S. Application Data
(60) Provisional application No. 62/469,281, filed on Mar. 9, 2017.

(51) Int. Cl. A01K 85/12

(52) U.S. Cl. CPC A01K 85/12

(57) ABSTRACT

A fish attracting device including a first rotating member configured to rotate about a first central axis in response to movement of the first rotating member relative to water, the first rotating member having at least one asymmetrical blade protrusion positioned to encourage rotation of the first rotating member relative to the water in response to the movement of the first rotating member relative to the water; and a second rotating member coupled to the first rotating member, the second rotating member being configured to rotate about a second central axis in response to movement of the second rotating member relative to the water, the second rotating member having an asymmetrical blade protrusion positioned to encourage rotation of the second rotating member relative to the water in response to the movement of the second rotating member relative to the water, the rotation of the second rotating member being substantially opposite the rotation of the first rotating member.

This application is related to, and claims the benefit of priority of, U.S. Provisional Application No. 62/469,281, entitled FISH ATTRACTOR OR LURE, filed on 9 Mar. 2017, the contents of which are incorporated herein by reference in their entirety for all purposes.

### FIELD OF THE INVENTION

The present invention relates to an attractor for fish species, and, preferably, to the attractor itself when rigged as a lure with hook(s).

### BACKGROUND OF THE INVENTION

There are many fish in salt and fresh waters that are the target species for people fishing. Some of the most desired saltwater species, include: Tuna, Striped Bass, Marlin, Sailfish, Dolphinfish or Mahi Mahi, Kingfish, Wahoo, Bluefish, Drum, Snook, False Albacore, Fluke, Halibut, Sharks and various other species with local names from around the globe.

When used in freshwater a lure may be used to catch sport fish such as Large and Small Mouth Bass, Pike, Muskellunge, Trout, Salmon, Walleye, Pickerel and Crappie in the United States. People may also wish to target and attract other fish species in other countries and locations.

One method employed to attempt to catch large game fish is to use a fish attractor also known as a teaser. The purpose and intent of the teaser is to attract fish to the vicinity of the person fishing so as to then have the fish, attracted by the teaser, be caught on another presented bait or lure.

One type of commercially available teaser consists of a heavy wire mesh attached between two boards and drawn or towed through the water in an attempt to create commotion on or just below the surface of the water body on which it is employed. The desired and targeted fish species are then drawn to the area of the commotion and enticed to feed on a presented lure or bait. Significant disadvantages of this commercial teaser are cost, size, weight, specialized equipment to use and effectiveness.

A further type of fish attractor is known as a squid bar. A squid bar consists of a rod or bar connected centrally and from which various imitation baits are arrayed in 3, 5, 7 or more lines in parallel to the direction of motion. A squid bar attempts to create surface commotion and simulate target bait species such as squid at or near the surface. Squid bars are constructed often with many artificial lures pulled at slower speeds to prevent tangling of the numerous arrayed lines. They can be difficult to present into the water and to function without constant monitoring and adjustment. Should it be desirable to move the boat quickly to reach nearby fish, the squid bar must be quickly removed from the water and then returned. Both operations risk tangling and loss of time to actively target and catch fish.

However, the current types of teasers available and disclosed do not meet all the requirements or needs of the fishing community and other options are sought. As described by U.S. Pat. No. 9,474,262, and included herein by reference, trolling teasers can be used to target/attract many different species of fish and include artificial “birds”, strings of small flashing spinners, painted boards and the like. Existing teasers are attached by a line at the front end of the teaser to drag or pull the teaser through the water.

U.S. Pat. No. 9,474,262 further describes a tubular body with apertures to create a disturbance so as to attract fish, but the disclosed intent is also to try to prevent the described teaser device from skipping across the surface while being trolled. U.S. Pat. Nos. 8,776,427 and 9,326,495 disclose a means of attaching an impeller to the output shaft of a motor so as to create rotational splashing as a suggested means to attract fish.

What is therefore required or desired is an improved fish attracting device to simulate the feeding of other fish species more accurately so as attract the desired and targeted species closer to the people fishing. There is also the need to resolve one or more of the limitations of existing teaser designs, outlined and described herein, so as to provide a more effective teaser.

### SUMMARY OF THE INVENTION

According to a first aspect of the invention, a fish attractor is provided including a first rotating member configured to rotate about a first central axis in response to movement of the first rotating member relative to water, the first rotating member having at least one asymmetrical blade protrusion positioned to encourage rotation of the first rotating member about the first central axis in response to the movement of the first rotating member relative to the water. The fish attractor is also provided with a second rotating member coupled to the first rotating member, the second rotating member being configured to rotate about a second central axis in response to movement of the second rotating member relative to the water, the second rotating member having an asymmetrical blade protrusion positioned to encourage rotation of the second rotating member relative to the second central axis in response to the movement of the second rotating member relative to the water, the rotation of the second rotating member being substantially opposite the rotation of the first rotating member.

The first rotating member can have a front section, a rear section, and a body section between the front section and the rear section, the asymmetrical blade protrusion extending from at least one of the front section, the rear section, and the body section. The second rotating member can also have a front section, a rear section, and a body section between the front section and the rear section, the asymmetrical blade protrusion extending from at least one of the front section, the rear section, and the body section.

The first rotating member can have a single asymmetrical blade protrusion, and the asymmetrical blade protrusion can be integrally formed on the first rotating member. The second rotating member can also have a single asymmetrical blade protrusion, and the asymmetrical blade protrusion can be integrally formed on the second rotating member.

The first and second central axes can be substantially parallel, and the flow of water past the fish attractor can impinge on the asymmetrical blade protrusion of the first rotating member, thus forcing rotation of the first rotating member about the first central axis, and the flow of water past the fish attractor can also impinge on the asymmetrical blade protrusion of the second rotating member, thus forcing rotation of the second rotating member about the second central axis. The first rotating member can rotate either clockwise or counter-clockwise about the first central axis, and the second rotating member can rotate either clockwise or counter-clockwise about the second central axis, such that the first rotating member and the second rotating member counter rotate in opposite directions regardless of the direction of rotation of the first rotating member.

The fish attractor can also include a first elongate member associated with the first rotating member and extending along the first central axis and a second elongate member associated with the second rotating member and extending along the second central axis, and the first elongate member and the second elongate member can be coupled for pivotal movement relative to one another.

The fish attractor can also include a connecting loop positioned to couple an end of the first elongate member to an end of the second elongate member. The first elongate member can include a wire or a flexible line or a flexible cable, and the second elongate member can also include a wire or a flexible line or a flexible cable. The fish attractor can also include at least one hook coupled adjacent to the first rotating member or the second rotating member.

According to another aspect of the invention, a fish attracting device includes a central axis; a first rotating member, freely able to rotate about the central axis; the first rotating member having a front section and a rear section with a body section therebetween; the first rotating member having a single integrally formed asymmetrical blade protrusion, and; at least one second rotating member, freely able to rotate about the central axis; the second rotating member having a front section and a rear section with a body section therebetween; the second rotating member having a single integrally formed asymmetrical blade protrusion, where; both or either of the single integrally formed asymmetrical blade protrusions include a scoop feature.

The flow of water past the fish attracting device can impinge on the integrally formed blade protrusion of the first rotating member forcing rotation of the first rotating member about the central axis; while the flow of water past the fish attracting device can also impinge on the blade protrusion of the second rotating member forcing rotation of the second rotating member about the central axis, where the scoop feature of both or either single integrally formed asymmetrical blade protrusion can project water during the rotation of the associated rotating member. Fish species can be attracted to the vicinity of the fish attracting device due to at least one of splashing, noise, vibration and flashing created by counter rotation of the first and second rotating members, and bird species can be attracted to the vicinity of the fish attracting device due to at least one of splashing, noise, vibration and flashing created by counter rotation of the first and second rotating members.

The fish attractor can also include a diving head coupled to the first rotating member or the second rotating member, the diving head including a diving plane positioned to impinge water in response to the movement of the diving head relative to the water.

The first rotating member and the second rotating member can be coupled in series, with one of the first rotating member and the second rotating member being behind the other. The central axis of the first rotating member and the central axis of the second rotating member can be generally aligned with one another.

According to another aspect of this invention, a fish attracting device includes plural fish attractors. The first rotating member and the second rotating member of each of the fish attractors can coupled in series, with one of the first rotating member and the second rotating member being behind the other. The fish attractors can also be arranged in parallel and coupled to extend from a single point or from multiple points.

A plurality of the fish attractors can be arranged in series. The fish attractors arranged in series can be coupled to extend from a single point or coupled via successive pivot points. The fish attractors arranged in series can be coupled along a common central axis to form a chain of fish attractors.

According to yet another aspect of the invention, the fish attracting device includes a first rotating member configured to rotate about a first central axis in response to movement of the first rotating member relative to water, the first rotating member having at least one asymmetrical blade protrusion positioned to encourage rotation of the first rotating member about the first central axis in response to the movement of the first rotating member relative to the water. The fish attracting device also includes a support coupled to the first rotating member and extending substantially perpendicular to the first central axis. A second rotating member of the fish attracting device is coupled to the first rotating member or to the support, the second rotating member being configured to rotate about a second central axis in response to movement of the second rotating member relative to the water, the second rotating member having an asymmetrical blade protrusion positioned to encourage rotation of the second rotating member relative to the second central axis in response to the movement of the second rotating member relative to the water, the rotation of the second rotating member being substantially opposite the rotation of the first rotating member.

The support can include a spreader bar or a squid bar. And the support can be coupled at its midpoint along the first central axis.

According to yet another aspect of the invention, a method of attracting fish includes placing a first rotating member and a second rotating member of a fish attractor in a body of water; and moving the fish attractor relative to the body of water causing the first rotating member to rotate about a first central axis in response to movement of the first rotating member relative to the body of water and causing the second rotating member to rotate about a second central axis in response to movement of the second rotating member relative to the body of water, such that the rotation of the second rotating member is substantially opposite the rotation of the first rotating member.

The moving step can include moving an asymmetrical blade protrusion of the first rotating member and an asymmetrical blade protrusion of the second rotating member relative to the body of water. The placing step can also include arranging the first rotating member and the second rotating member of the fish attractor in series, with one of the first rotating member and the second rotating member being behind the other. Additionally, the placing step can also include placing a plurality of fish attractors in the body of water; placing the plurality of fish attractors such that at least two of the fish attractors are arranged in parallel; and/or placing the plurality of fish attractors such that at least two of the fish attractors are arranged in series. Also, the moving step can include at least one of towing, trolling, casting, retrieving and drifting the fish attractor relative to the body of water.

### BRIEF DESCRIPTION OF THE DRAWINGS

FIG. 1 is a front isometric perspective view illustrating the construction and key features of an embodiment of the invention.

FIG. 2 is a rear isometric perspective view illustrating the construction and key features of an embodiment of the invention.

FIG. 3 is a front isometric perspective view illustrating the principles of operation of an embodiment of the invention.

FIG. 4 is a front elevation view of an embodiment of the invention.

FIG. 4A is a detail view of a further embodiment of the invention.

FIG. 5 is a cross-sectional elevation view of an embodiment of the invention.

FIG. 6 is a front isometric perspective view of a preferred embodiment of the invention.

FIG. 7 is a front isometric perspective view of a further embodiment of the invention.

FIG. 8A is a schematic view of alternative method of use and assembly configuration according to an aspect of this invention.

FIG. 8B is a schematic view of alternative method of use and assembly configuration according to an aspect of this invention.

FIG. 9 is a schematic view of alternative method of use and assembly configuration according to an aspect of this invention.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

This invention will now be described with reference to several embodiments selected for illustration in the drawings. It will be appreciated that the scope and spirit of the invention are not limited to the illustrated embodiments. It will further be appreciated that the drawings are not rendered to any particular proportion or scale. Also, any dimensions referred to in the description of the illustrated embodiments are provided merely for the purpose for illustration. The invention is not limited to any particular dimensions, materials, or other details of the illustrated embodiments.

In an exemplary embodiment, the present invention provides a device for enticing fish to the proximity of the device by means of translating rotational energies into splashing, vibration, sound and flashing. The intent and wish of those fishing is to simulate the effect of other fish species feeding. When configured as a fish catching lure with the addition of a hook or hooks the device can then catch the attracted fish using the same principles and design elements as those used in the teaser version of this invention.

According to aspects of the present invention, it is possible to reduce or eliminate disadvantages associated with existing trolling teasers, such as that they twist or rotate in the water, jump out of the water, dive excessively and/or erratically, or that they are not realistic enough to properly attract fish when being trolled, create substantial drag, suffer from potential loss of direct sight to the device, and/or lack other fish attracting features such as an extended spray profile and the flashing of moving elements. Also, according to aspects of the present invention, it is possible to eliminate attachment to, and the rotational drive of, a motor to achieve surface splashing in a single rotational direction, thus making it possible to avoid a fixed axis of rotation with respect to the motor shaft and/or an impeller proximate to the motor and boat, such that the fish attractor can be some distance and disconnected from the drive or propulsion means of the boat. These principles and elements will now be described.

Referring generally to the figures, and according to one aspect of the invention, a fish attractor 5 is provided including a first rotating member 20 configured to rotate about a first central axis 10 in response to movement of the first rotating member 20 relative to water, the first rotating member 20 having at least one asymmetrical blade protrusion 30 positioned to encourage rotation of the first rotating member 20 about the first central axis 10 in response to the movement of the first rotating member 20 relative to the water; and a second rotating member 40 coupled to the first rotating member 20, the second rotating member 40 being configured to rotate about a second central axis 10 in response to movement of the second rotating member 40 relative to the water, the second rotating member 40 having an asymmetrical blade protrusion 50 positioned to encourage rotation of the second rotating member 40 relative to the second central axis 10 in response to the movement of the second rotating member 40 relative to the water, the rotation of the second rotating member 40 being substantially opposite the rotation of the first rotating member 20.

The first rotating member 20 can have a front section 21, a rear section 22, and a body section 23 between the front section 21 and the rear section 22, the asymmetrical blade protrusion 30 extending from at least one of the front section 21, the rear section 22, and the body section 23. Similarly, the second rotating member 40 can have a front section 41, a rear section 42, and a body section 43 between the front section 41 and the rear section 42, the asymmetrical blade protrusion 50 extending from at least one of the front section 41, the rear section 42, and the body section 43.

The first rotating member 20 can have a single asymmetrical blade protrusion 30, and the asymmetrical blade protrusion can be integrally formed on the first rotating member 20. Similarly, the second rotating member 40 can have a single asymmetrical blade protrusion 50, and the asymmetrical blade protrusion 50 can be integrally formed on the second rotating member 40.

The flow of water past the fish attractor 5 can impinge on the asymmetrical blade protrusion 30 of the first rotating member 20, thus forcing rotation of the first rotating member 20 about the first central axis 10; and the flow of water past the fish attractor 5 can also impinge on the asymmetrical blade protrusion 50 of the second rotating member 40, thus forcing rotation of the second rotating member 40 about the second central axis 10. Also, the first and second central axes 10, 10 can be substantially parallel.

The first rotating member 20 can rotate either clockwise or counter-clockwise about the first central axis 10, and the second rotating member 40 can rotate either clockwise or counter-clockwise about the second central axis 10, such that the first rotating member 20 and the second rotating member 40 counter rotate in opposite directions regardless of the direction of rotation of the first rotating member 20.

The fish attractor can also include a first elongate member 60 associated with the first rotating member 20 and extending along the first central axis 10 and a second elongate member 70 associated with the second rotating member 40 and extending along the second central axis 10, the first elongate member 20 and the second elongate member 40 being coupled for pivotal movement relative to one another. A connecting loop 61 can be positioned to couple an end of the first elongate member 60 to an end of the second elongate member 70. The first elongate member 60 or the second elongate member 70 can include a wire or flexible line or cable. The fish attractor 5 can include at least one hook 221 coupled adjacent to the first rotating member 20 or the second rotating member 40.

According to another aspect of the invention, a fish attractor including rotating and linked members about a connected or continuous central axis is provided. Each rotating member has a single asymmetrical blade design protruding only from one side of the body. The flow of water past the attractor due to the action of towing, trolling, casting or drifting causes the bladed members to rotate in opposite directions. The design of the single asymmetrical blade includes a scoop or cup feature 35 to assure rotation in the desired and opposite directions. The scoop feature 35 of the blade also projects water away from the attractor due to the inertial energy of the rotation. When used as a surface attractor and towed, trolled or cast some distance from a boat, the counter rotating action of the linked members creates a considerable and noticeable commotion to attract and catch fish.

For those skilled in the art it is clear the term blade can encompass fins, vanes or other types of structures such as asymmetrical transverse protrusions from a central body.

Each rotating or counter rotating member of the attractor may be made of reflective materials or have a reflective tape or “eye” bonded to it so as to reflect light and to flash as it rotates. This rotation, rolling and flashing mimics the motion of distressed fish species and draws in target species to investigate or feed. The rotation of the members caused by the integrally formed asymmetrical blade likewise attracts fish due to the percussive effect of the blade rotation.

While a preferred embodiment of the attractor is intended to be used as a surface teaser, the disclosed invention is not limited to being used only on or at the surface of the water. The rotating bodies may be weighted so as to sink such that the counter rotating action of the attractor functions below the surface. In this embodiment, the rotating members may be preferably made of a metal or other non-buoyant material and optionally coated to create a reflective surface. Those skilled in the art understand a surface teaser may also be effectively used underwater by the use of a leading weight or downrigger system. The method of using a floating lure or surface teaser weighted to function underwater is known to limit unintended contact with structures when the forward motion due to casting, trolling, towing or drifting is slowed. As an underwater lure, the features of the preferred embodiment of the attractor, including the percussive effect of the scoop feature of the blade and the flash due to rotation may be enhanced by the transmission of light and sound through water.

Additionally, it may be known by those skilled in the art of fishing that the presence of diving birds suggests fish feeding at or close to the surface. The noise and commotion created by diving birds further attracts the target fish species. The teaser of the present invention has been demonstrated to attract birds to the vicinity of the attractor from large distances and for these birds to dive at the water in the vicinity of the attractor. The presence of attracted birds to the attractor increases the effectiveness of the disclosed invention to attract and catch fish.

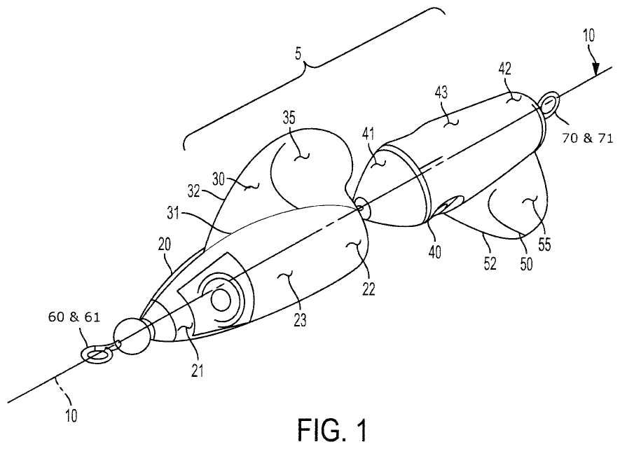

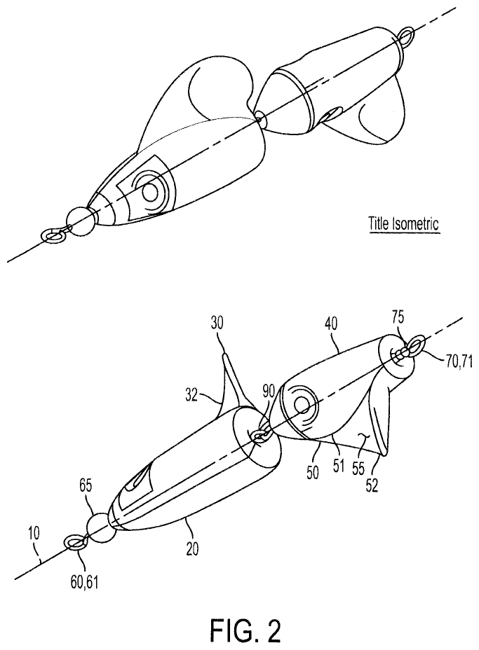

Referring now to selected figures, details of embodiments of the invention will be described. FIGS. 1-2 illustrate the basic construction and features of the invention in a preferred embodiment. A central axis 10 of rotation is formed by wire or flexible line/cable about which the first rotating member 20 and second rotating member 40 are allowed to freely rotate. First rotating member 20 may be preferably cylindrical with a front section 21, rear section 22 and body section between 23. Similarly, second rotating member 40 may be preferably cylindrical with a front section 41, rear section 42 and body section 43 therebetween.

First rotating member 20 has an integrally formed blade 30 protruding asymmetrically. Blade 30 beginning at or near the front section 21 has base 31, leading edge 32 and scoop 35. The blade 30 extends from the front section, first rotating member 20 parallel and streamlined to the central axis 10. The blade 30 also grows in asymmetrical height extending above the body of the first member 20 reaching a maximum height at the rear section 22. As the blade 30 increases in height above the body 20 the edge 31 and base 32 curl around the body section 23 terminating at the rear section 22 to form the blade scoop 35. Blade 30 with edge 31, base 32 and scoop 35 may be proportioned in any combination so as to create the preferred rotation 121 due to direction of pull 100.

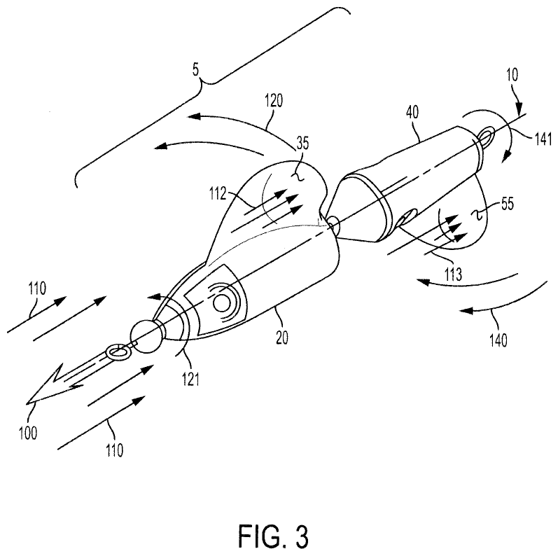

FIG. 3 is used to illustrate the principles of operation of the invention. Attractor 5 may be deployed via a number of known means including towing, trolling, casting and retrieving or drifting in a fixed position in the current. All these methods create a directional motion 100 which is pulling the attractor 5 through or past the surrounding water. Due to motion 100, water flows 110 past both the first rotating member 20 and second rotating member 40. Water flow 110 moves across integrally formed blade 30 and impinges 112 on scoop 35 creating force vector 120. Force vector 120 imparts energy to the integrally formed blade 30 of first rotating member 20 resulting in rotation 121 of first rotating member 20 about the central axis 10. Congruently, water flow 110 moves across integrally formed blade 50 and impinges 113 on scoop 55 creating force vector 140. Force vector 140 imparts energy to the integrally formed blade 50 of second rotating member 40 resulting in rotation 141 of second rotating member 20 about the central axis.

In the preferred embodiment when moved across the surface of water in direction 100, scoop 35 of integrally formed blade 30 protruding asymmetrically from first member 20 creates a rotation 121 in the opposite direction to scoop 55 of integrally formed blade 50 protruding asymmetrically from second member 40 rotating in direction 141. The opposing rotations 121 and 141 about the central axis 10 of rotating members 20 and 40 both with integrally formed asymmetric blades 30 and 50 creates a churning visual and audible disturbance in the water so as to attract fish.

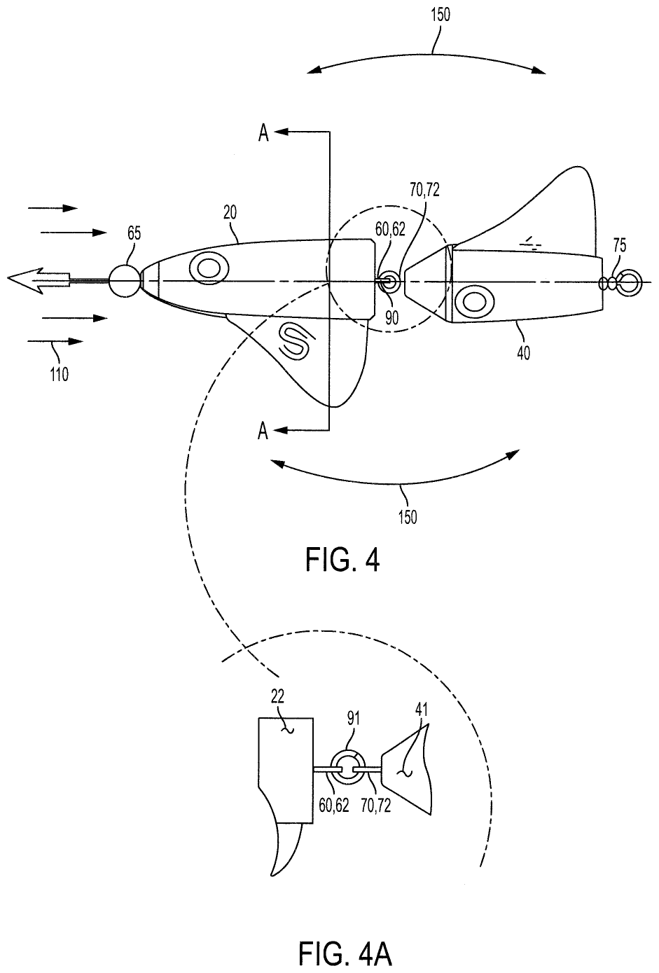

FIG. 4 represents a preferred embodiment. The central axis 10 is formed not by a single wire or flexible line and/or cable but by two wires 60, 70 connected together at the pivot point 90 so as to form a coaxial central axis 10. Some of the target fish species can be large, such as Bluefin Tuna with weights approaching 1,000 lbs. In a preferred embodiment the wire or flexible line and/or cable should be of sufficient strength to be stronger than the fishing line used to catch such fish. A preferred embodiment has each of the wire or flexible lines and/or cables 60, 70 with strengths of greater than 500 lbs. test.

First rotating member 20 is constrained on first wire or flexible line and/or cable 60 between front loop 61 and first wire or flexible line and/or cable center loop 62. Second rotating member 40 is constrained on second wire or flexible line and/or cable 70 between rear wire or flexible line and/or cable loop 71 and second wire or flexible line and/or cable center loop 72. Front bead 65 allows free rotation of first rotating member 20 without binding or galling between front loop 61 and the front section 21. Furthermore, rear bead 75 provides a similar function between the second rotating member and the rear wire or flexible line and/or cable loop. As can be appreciated, front bead 65 and rear bead 75 may be made of various materials and colors so as to achieve the desired performance attributes of the invention. In a preferred embodiment, front bead 65 is a red acrylic while rear bead 75 is polished stainless steel. It is important to the function that front bead 65 and rear bead 75 do not rust, corrode or dissolve with exposure to freshwater, seawater and sun.

FIG. 4A is a detailed view showing an alternative means to create the pivot point 90. Front wire or flexible line and/or cable, center loop 62 may be directly connected to second wire or flexible line and/or cable, center loop 72 so as to form the pivot point 90, alternatively, as shown, a split ring 91 may be used to join the two wire or flexible lines and/or cables, 60 and 70. Creating the pivot point 90 using a split ring 91 may provide for manufacturing and cost to produce advantages while also providing an attachment point for other enhancements of the disclosed invention. For example; a hook may be selectively attached at the center pivot.

In an exemplary embodiment, force vectors 120 and 140 create energy at the central pivot point 90 further enhancing the movement 150 between front rotating member 20 and rear rotating member 40. This additional motion 150 creates more movement of the attractor 5 thus creating further splashing, vibration, flashing and noise in the water to attract fish to the attractor 5.

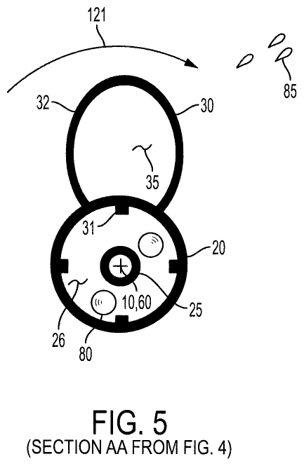

FIG. 5 shows a cross-section through front rotating member 20 at or about the transition of the body section 23 to the rear section 22 of the first rotating member. It is understood that the sectional view is representational and all features and proportions are shown to describe the invention but may not be to scale or in exact locations. The form and function of the single integrally formed asymmetrical blade, including the scoop 35, can be clearly seen and understood from this figure.

However, certain features of the attractor, including the blade contour and other features, are selected for ornamental design and are not dictated by practical function. Accordingly, design elements of the attractor 5 can be varied and selected while maintaining functionality, such that a variety of ornamental configurations are available with substantially the same function or performance. For example, the contours and configurations of the blades 30, 50 can be varied to provide a different ornamental appearance while maintaining substantially the same functionality. The same holds true for the shape of the first and second rotating members. The ornamental design of the attractor 5 is protected separately in U.S. Design patent application Ser. No. 29/596,616, filed Mar. 9, 2017.

The asymmetrical blade 30 is formed as part of and is integral to the body 20 or alternatively to the second rotating member, blade 50 and rotating member 40. In a preferred embodiment the rotating body members, 20, 40 and integrally formed asymmetrical blades 30, 50 may be manufactured from a number of processes and from differing materials. Processes may include: molding, machining, casting or other means known to form complex structures quickly and with dimensional repeatability and stability. The materials for the rotating body members, 20, 40 and integrally formed asymmetrical blades 30, 50 may include: plastics, structural foams, metals or composites.

The scoop feature 35 of blade 30 is formed by the leading edge 32 and blade base 31. As the blade 30 extends from the front section 21 around the body section 23 towards the rear section 22 the base edge 31 curls away from parallelism to the central axis as does the leading edge 32. This curl creates the scoop 35 of blade 30.

Scoop 35, driven by impinging water 112 creates force vectors 120 which in turn generate rotation 121 of the member. Rotation of any members creates vibration and noise due to the cavitation effect of the single integrally formed asymmetrical blades which then attract fish. The effect of creating the perception of feeding fish is further enhanced by flashing elements alternatively attached to the blades, or body in the form of an eye, as well the noise created by the alternatively included rattle ball(s) 80 in the hollow chamber. The attraction effect is increased by water 85 projected away from the attractor 5 by the scoops 35, 55 in the rotating blades 30, 50 to simulate fish feeding and attempting to evade predation. Smaller fish being eaten or attacked by larger fish or birds attracts the larger and target species of fish.

The same principles used to design and construct the single integrally formed asymmetrical blade 30 of first rotating member 20 may be applied to subsequent and alternative integrally formed asymmetrical blades of other rotating members such that the direction of rotation 141 is opposite to first member rotating in direction 121.

As illustrated, first rotating member 20 and, or alternatively, second rotating member 40, may be hollow with a center hub 25 forming the means to accept and guide central axis 10. So as to enhance the attraction effect while rotating, a rattle ball 80 may be enclosed and sealed in the hollow body of the rotating member. To further enhance the effectiveness of rattle ball 80 during rotation, a number of rattle ribs 26 may be included. The rattle rib 26 causes the rattle ball 80 to move more erratically and frequently so as to enhance the noise and vibration created by the rotation.

While the preferred embodiment is shown with a single asymmetrical blade, it can be clearly understood that counter rotating member can have two, three or multiple blades to create the desired and intended counter rotation. For example, plural blades can be positioned about the circumference of one or more of the rotating members. Also, plural blades can be positioned along the length of one or more of the rotating members. Such blades can be spaced evenly or at various locations.

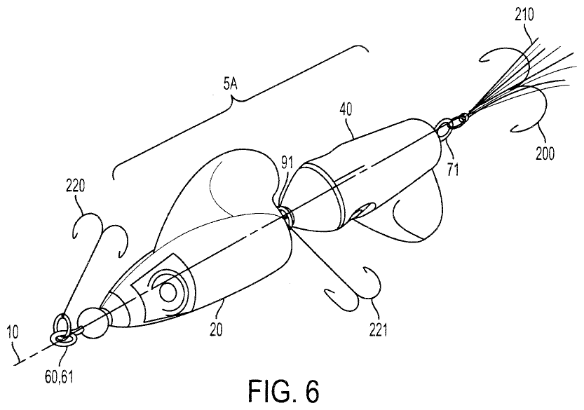

FIG. 6 is an exemplary embodiment when the attractor 5A is configured to also catch the attracted fish with the addition of hooks. Rear hook 220 may be attached to the central axis at rear loop 71 while a further hook may be attached at the front loop 61. Additionally, a hook 221 may be attached at each successive pivot point. Rear hook dressing 210 in the form of feathers, thread, and rubber may be used to enhance the visual effect. In smaller version of the preferred embodiment, rear dressing 210 acts to create drag in the water to assist in keeping the central axis pointed towards the direction of pull 100.

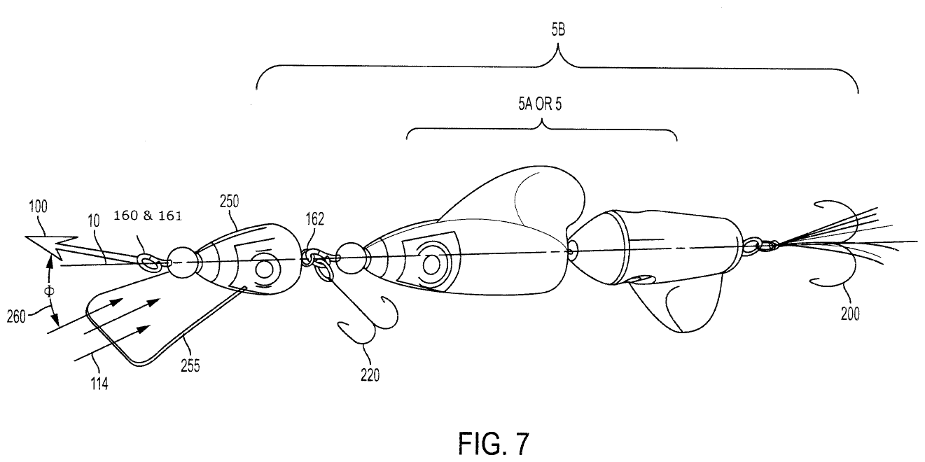

FIG. 7 represents a further embodiment of the attractor configured as a lure to catch fish. As is clearly understood, the attractor can be made of materials to allow it to float, have neutral buoyancy or to sink as may be preferred for the desired target species of fish. Alternatively, the hollow body of the rotating members may be eliminated or the rattle ball(s) may be of denser materials such as metal to weigh down and to sink the attractor 5 or 5A. However, so as to control the depth of the attractor when moved through and below the water is helpful to have the attractor float and return to the surface due to positive buoyancy when not pulled 100.

So as to draw the attractor 5B below the surface while still allowing for the disclosed and described function of the counter rotating members a dive head 250 is attached to the front. Head wire or flexible line and/or cable 160 comprises a head loop 161 and center loop 162 rigidly attached to the dive head 250. Unlike the first rotating member 20 and at least one second rotating member 40, dive head 250 does not rotate about the formed central axis extension of wire or flexible line and/or cable 160. Dive head 250 with rigidly fixed head wire or flexible line and/or cable 160 form an extension of front loop 60 in the preferred embodiment. Dive head 250 is rigidly attached to the wire or flexible line and/or cable 160 so as to not rotate and allow for the action of dive plane 255 to draw the entire attractor 5B below the surface of the water when pulled 100. Water impinges on the dive plane 114 at the dive angle θ 260 from horizontal which pulls the entire attractor below the surface. It can be understood that the depth the attractor dives to is controlled by the size of the diving plane 255, diving angle θ 260 and pull force 100. It is further known that pull force 100 is controlled by the speed at which the attractor 5B is drawn through the water.

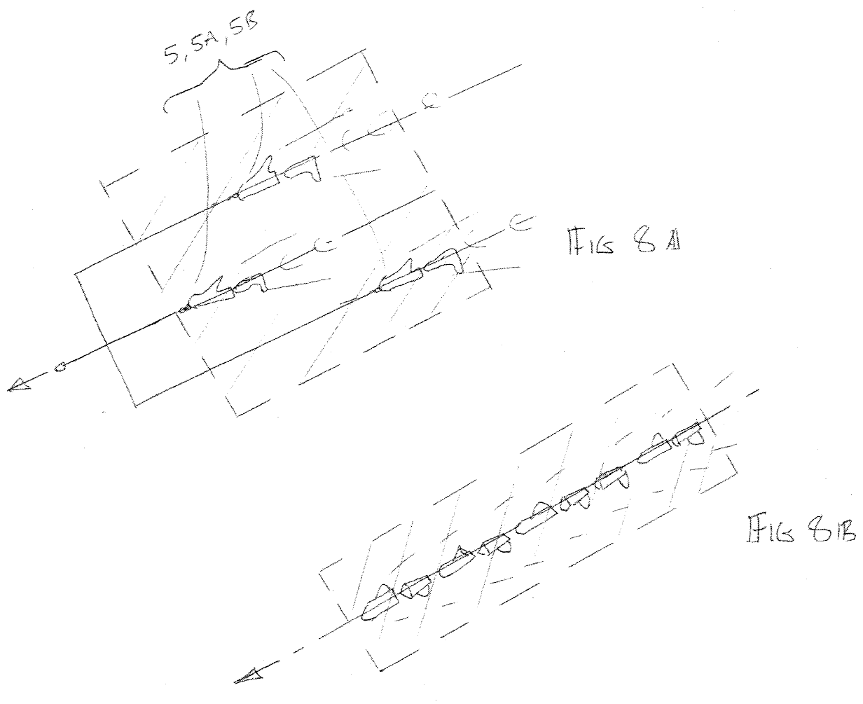

It can also be understood that multiple sets of counter rotating members may be connected together through successive pivot points along a common central axis to form a “daisy” chain of fish attractors as shown in FIG. 8B. Moreover, FIG. 8A shows how several attractors 5 or 5A or 5B or some combination thereof may be rigged to be pulled in parallel from a single point, or multiple points. In these and other combinations and manifestations, including weighted embodiments running deeper in the water, the use of multiple attractors connected in some fashion creates a larger area of interest to the target species.

The method of creating flow past the device 110 so at create rotation 121, 141 due to pull force 100 may be achieved by any number of known methods. The attractor 5, 5A, 5B may be pulled through water or alternatively towed, trolled or casted and retrieved. Other methods such as attaching to a fixed point in the water to create force 100 and allowing the passing current to flow by the device 110 or other similar techniques known to those who fish may be used.

Furthermore, the attractor 5, 5A may have a preferred embodiment of rotating at the surface to create splashes, noise and flashes to simulate feeding fish. Additionally, the same effects can occur below the surface when pulled using a secondary device such as a planer board, dipsy diver, and cannonball weight all often used with an outrigger.

Counter rotation about a common axis is preferred and beneficial to help maintain direction and stability in the water which may not be easily achieved by a single member with a single blade which may track. The counter rotation also causes imbalance at the pivot point 90 which is enhanced by having at least two coupled members.

Another noted benefit of the increased splashing due to the counter rotation and projected water 85 in the preferred embodiment is the means to see the attractor 5 at a greater distance and thus determine the location of potentially attracted fish.

The counter rotation lessens drag by using the energy of the impinging water 112, 113, to drive rotation and create splashing. It is not necessary to pull the attractor hard or more erratically to create the same desired splashing effects.

The surface curvature of the scoop 35, 55, may help to drive rotation 121, 141 of the members and also serve to provide a cavitation effect similar to the rotation of a propeller. The counter rotation of the at least two members enhances the cavitation and disturbance effect.

Counter rotation also helps to maintain the blade at least partially submerged in water to reduce or prevent skipping, skimming or jumping across the water. Also, a common axis can be jointed to provide more movement between the portions of the attractor. Joints in a common axis also provide options and places for attaching hooks.

The rear loop 71 provides the selective and alternate means for further lures or baits to be attached behind the attractor 5, 5A, 5B so as to catch with a hook fish attracted to the vicinity of the attractor 5.

So as to enhance the effect of the rotation, flashing elements in the form of strips or circles or resembling eyes may be incorporated. These flashing elements may be incorporated to the body members or alternatively to the blades as well.

A weight may be added to the nose of either member 20, 40 or the material selected may be such to cause the attractor 5 to sink. This provides for the advantageous features of rotation, vibration, noise and flashing to be utilized below the surface of the water as well.

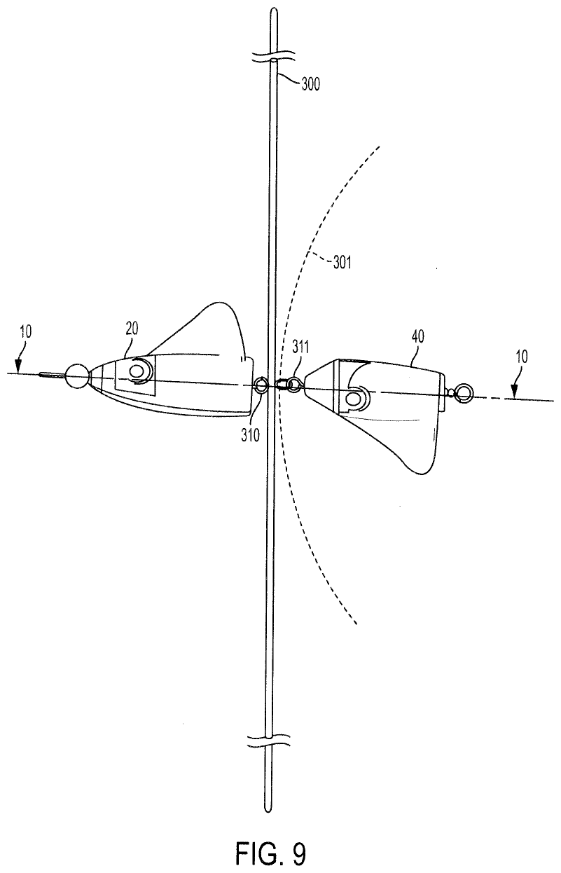

FIG. 9 illustrates a further embodiment of the attractor configured and used to provide buoyancy to support the weight of a structural member such as support 300. Support 300 may be a spreader bar or a squid bar or may be another component or subassembly. For example, support 300 may include a curved structural member 301. The coupling of the first rotating member 20 to the structural member or support 300 or 301, may be optionally achieved by means of a swivel or snap connector 310. Further, second rotating member 40 may be optionally coupled to the support 300 or 301, by means of a swivel, or snap connector, 311.

The preferred design has ornamental blades as described. One embodiment so as to create the effect of small dart fish rather than those feeding may be to have a smaller fin than creates oscillation of the member but may not create full and or continuous rotation.

For those skilled in the art it will be appreciated that the claimed invention, construction method and principles of operation are not limited solely to the embodiments described herein.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

### REFERENCE NUMBERS

5 Fish attracting device
5A Fish attracting device with hook(s)
5B Fish attracting device with diving head and hook(s)
10 Central axis
20 First rotating member
21 Front section, First rotating member
22 Rear section, First rotating member
23 Body section, First rotating member
25 Center hub
26 Rattle rib
30 Integrally formed blade, First rotating member
31 Blade base, First rotating member
32 Leading edge, Blade 30
35 Scoop, Integrally formed blade, First rotating member
40 Second rotating member
41 Front section, Second rotating member
42 Rear section, Second rotating member
43 Body section, Second rotating member
50 Integrally formed blade, Second rotating member
51 Blade base, Second rotating member
52 Leading edge, Blade 50
55 Scoop, Integrally formed blade, Second rotating member
60 Front wire or flexible line and/or cable
61 Front wire or flexible line and/or cable loop
62 Front wire or flexible line and/or cable, center loop
65 Front bead
70 Rear wire or flexible line and/or cable
71 Rear wire or flexible line and/or cable loop
72 Rear wire or flexible line and/or cable, center loop
75 Rear Bead
80 Rattle ball
85 Projected water
90 Pivot point
91 Pivot point split ring
100 Direction of pull from tow, troll, cast or drift in current
110 Direction and flow of water over attractor
112 Water impinging on Scoop, Integrally formed blade, First rotating member
113 Water impinging on Scoop, Integrally formed blade, Second rotating member
114 Water impinging on Diving plane of diving head
120 Direction of force vector, first rotating member blade
121 Direction of rotation of first rotating member
140 Direction of force vector, second rotating member blade
141 Direction of rotation of second rotating member
160 Head wire or flexible line and/or cable
161 Head wire or flexible line and/or cable loop
162 Head wire or flexible line and/or cable, center loop
200 Rear hook
210 Rear hook dressing
220 Front hook
221 Pivot hook
250 Diving head
255 Diving plane
260 Diving angle
300 Structural member or support
301 Curved structural member or support
310 Coupling means, first rotating member
311 Coupling means, second rotating member

1. A fish attractor comprising:
a first rotating member configured to rotate about a first central axis in response to movement of the first rotating member relative to water, the first rotating member having at least one asymmetrical blade protrusion positioned to encourage rotation of the first rotating member about the first central axis in response to the movement of the first rotating member relative to the water; and
a second rotating member coupled to the first rotating member, the second rotating member being configured to rotate about a second central axis in response to movement of the second rotating member relative to the water, the second rotating member having an asymmetrical blade protrusion positioned to encourage rotation of the second rotating member relative to the second central axis in response to the movement of the second rotating member relative to the water, the rotation of the second rotating member being substantially opposite the rotation of the first rotating member.

2. The fish attractor of claim 1, at least one of the first rotating member and the second rotating member having a front section, a rear section, and a body section between the front section and the rear section, the asymmetrical blade protrusion extending from at least one of the front section, the rear section, and the body section.

3. (canceled)

4. The fish attractor of claim 1, at least one of the first rotating member and the second rotating member having a single asymmetrical blade protrusion.

5. The fish attractor of claim 1, the asymmetrical blade protrusion being integrally formed on at least one of the first rotating member and the second rotating member.

6. (canceled)

7. (canceled)

8. The fish attractor of claim 1, the first and second central axes being substantially parallel.

9. The fish attractor of claim 1, wherein flow of water past the fish attractor impinges on the asymmetrical blade protrusion of the first rotating member, thus forcing rotation of the first rotating member about the first central axis; and wherein the flow of water past the fish attractor also impinges on the asymmetrical blade protrusion of the second rotating member, thus forcing rotation of the second rotating member about the second central axis.

10. The fish attractor of claim 1, wherein the first rotating member rotates either clockwise or counter-clockwise about the first central axis, and the second rotating member rotates either clockwise or counter-clockwise about the second central axis, such that the first rotating member and the second rotating member counter rotate in opposite directions regardless of the direction of rotation of the first rotating member.

11. The fish attractor of claim 1, further comprising a first elongate member associated with the first rotating member and extending along the first central axis and a second elongate member associated with the second rotating member and extending along the second central axis, the first elongate member and the second elongate member being coupled for pivotal movement relative to one another.

12. The fish attractor of claim 11, further comprising a connecting loop positioned to couple an end of the first elongate member to an end of the second elongate member.

13. The fish attractor of claim 11, wherein at least one of the first elongate member and the second elongate member comprises a wire or a flexible line or a flexible cable.

14. (canceled)

15. The fish attractor of claim 1, further comprising at least one hook coupled adjacent to the first rotating member or the second rotating member.

16. A fish attracting device, comprising:
a central axis;
a first rotating member, freely able to rotate about the central axis;
the first rotating member having a front section and a rear section with a body section therebetween;
the first rotating member having a single integrally formed asymmetrical blade protrusion, and;
at least one second rotating member, freely able to rotate about the central axis;
the second rotating member having a front section and a rear section with a body section therebetween;
the second rotating member having a single integrally formed asymmetrical blade protrusion, where;
both or either of the single integrally formed asymmetrical blade protrusions include a scoop feature.

17. The fish attracting device of claim 16, where;
the flow of water past the fish attracting device impinges on the integrally formed blade protrusion of the first rotating member forcing rotation of the first rotating member about the central axis;
while the flow of water past the fish attracting device also impinges on the blade protrusion of the second rotating member forcing rotation of the second rotating member about the central axis, where,
the scoop feature of both or either single integrally formed asymmetrical blade protrusion projects water during the rotation of the associated rotating member.

18. (canceled)

19. (canceled)

20. (canceled)

21. The fish attractor of claim 1, the first rotating member and the second rotating member being coupled in series, with one of the first rotating member and the second rotating member being behind the other.

22. The fish attractor of claim 21, wherein the central axis of the first rotating member and the central axis of the second rotating member are generally aligned with one another.

23. A fish attracting device comprising plural fish attractors according to claim 1.

24. The fish attracting device of claim 23, wherein the first rotating member and the second rotating member of each of the fish attractors are coupled in series, with one of the first rotating member and the second rotating member being behind the other.

25. The fish attracting device of claim 24, wherein a plurality of the fish attractors are arranged in parallel.

26. The fish attracting device of claim 25, wherein the fish attractors arranged in parallel are coupled to extend from a single point.

27. The fish attracting device of claim 25, wherein the fish attractors arranged in parallel are coupled to extend from multiple points.

28. The fish attracting device of claim 24, wherein a plurality of the fish attractors are arranged in series.

29. The fish attracting device of claim 28, wherein the fish attractors arranged in series are coupled to extend from a single point.

30. The fish attracting device of claim 28, wherein the fish attractors arranged in series are coupled via successive pivot points.

31. The fish attracting device of claim 28, wherein the fish attractors arranged in series are coupled along a common central axis to form a chain of fish attractors.

32. A fish attracting device comprising:
a first rotating member configured to rotate about a first central axis in response to movement of the first rotating member relative to water, the first rotating member having at least one asymmetrical blade protrusion positioned to encourage rotation of the first rotating member about the first central axis in response to the movement of the first rotating member relative to the water;
a support coupled to the first rotating member and extending substantially perpendicular to the first central axis; and
a second rotating member coupled to the first rotating member or to the support, the second rotating member being configured to rotate about a second central axis in response to movement of the second rotating member relative to the water, the second rotating member having an asymmetrical blade protrusion positioned to encourage rotation of the second rotating member relative to the second central axis in response to the movement of the second rotating member relative to the water, the rotation of the second rotating member being substantially opposite the rotation of the first rotating member.

33. The fish attracting device of claim 32, wherein the support comprises a spreader bar or a squid bar.

34. The fish attracting device of claim 32, wherein the support is coupled at its midpoint along the first central axis.

35. (canceled)

36. (canceled)

37. (canceled)

38. (canceled)

39. (canceled)

40. (canceled)

41. (canceled)
